(19) United States
(12) Patent Application Publication
(10) Pub. No.: US 2016/0114760 A1
(43) Pub. Date: Apr. 28, 2016

(54) SAFETY HARNESSES

(71) Applicant: KIDS IP LIMITED, Glasgow (GB)

(72) Inventor: Alexander Crawford, Bellshill (GB)

(73) Assignee: Kids IP Limited, Glasgow (GB)

(21) Appl. No.: 14/895,844

(22) PCT Filed: Jun. 6, 2014
(86) PCT No.: PCT/GB14/51754

§ 371 Date: Dec. 3, 2015

(30) Foreign Application Priority Data
Jun. 6, 2013 (GB) 1310076.3

(51) Int. Cl. B60R 22/02; B60N 2/28

(52) U.S. Cl. CPC B60R 22/024; B60N 2/2866

(57) ABSTRACT

An accessory (10) for a safety harness which includes a diagonal shoulder belt (100), the accessory comprising a first end portion (20) which is attached or attachable to the shoulder belt at or around shoulder level; a second end portion (30) which is attached or attachable to a mounting point of the safety harness, the mounting point being substantially immovable relative to at least a part of the safety harness; and a belt member (40) extending between the first and second end portions such that, in use, the belt member extends around the back of a user from shoulder to hip level, thus forming at least part of a loop with the shoulder belt to assist in maintaining the position of the shoulder belt.

The present invention relates to safety harnesses and accessories. In particular, but not exclusively, the invention relates to devices for maintaining the position of a vehicle seatbelt during use by an occupant of the vehicle.

Vehicle seatbelts reduce injuries by at least one of: preventing the occupant from hitting hard interior components of the vehicle or being thrown from the vehicle; ensuring the occupant is in the correct position for a deploying airbag; absorbing energy by stretching of the seatbelt material; and spreading the impact load on the occupant's body. By far the most commonly used vehicle seatbelt is the three point system, which comprises a lap belt and a shoulder or sash belt.

In the UK, compulsory seatbelt wearing was extended to child occupants under the age of 14 in 1989. However, this resulted in over a 10% increase in fatalities and injuries. This was due to the three-point seatbelt system not being suitable for the different size and weight of children and the different relative proportions of their bodies. In response to the increasing figures, the use of separate child-sized seats with their own restraints and booster cushions for older children are now mandatory.

However, booster cushions still rely on the existing seatbelt system and the seatbelt can still be in an inappropriate or uncomfortable position (for instance, the edge of the belt may rub against the child's neck). Also, children tend to be more restless and/or sit in unorthodox positions, as well as be less safety conscious, and the seatbelt may adopt an inappropriate position as a result of their movement/position. Indeed, it is common for a child to remove the belt completely or at least laterally move the belt to the side (below the shoulder). The child then has no or significantly reduced protection from the seatbelt in the event of a crash.

It is desirable to provide an improved seatbelt system which helps maintain the belt at the appropriate position. It is desirable to provide an improved seatbelt system which helps maintain the belt at a comfortable position. It is desirable to provide an improved seatbelt system which makes moving the belt from the appropriate position more difficult.

According to a first aspect of the present invention there is provided an accessory for a safety harness which includes a diagonal shoulder belt, the accessory comprising:
a first end portion which is attached or attachable to the shoulder belt at or around shoulder level;
a second end portion which is attached or attachable to one of the shoulder belt at or around hip level or the buckle tongue; and
a belt member extending between the first and second end portions such that, in use, the belt member extends around the back of a user from shoulder to hip level, thus forming a loop with the shoulder belt to assist in maintaining the position of the shoulder belt.

The first end portion may be removably attachable to the shoulder belt. The first end portion may include a cushion portion. The first end portion may include an enclosure member which wraps around or otherwise encloses a portion of the shoulder belt at shoulder level.

The second end portion may be removably attachable to the shoulder belt or the buckle tongue. The second end portion may comprise a loop member for receiving the buckle tongue prior to insertion of the buckle tongue into the buckle. This eliminates the need for separate attachment of the second end portion.

At least a portion of the belt member may be resilient or elasticated. This allows relative separation of the first and second end portions under a tensile force.

The elasticity of the portion of the belt member may be predetermined to be at least greater than the elasticity of the shoulder belt.

The belt member may be resilient or elasticated. The elasticity of the belt member may be predetermined to be at least greater than the elasticity of the shoulder belt.

The length of the shoulder belt between the first and second end portions may be adjustable.

The safety harness may comprise a three point belt system.

According to a second aspect of the present invention there is provided a safety harness including an accessory according to the first aspect of the invention.

According to a third aspect of the present invention there is provided a booster cushion including an accessory according to the first aspect of the invention.

According to a fourth aspect of the present invention there is provided a method of maintaining the position of a safety harness in use, the safety harness including a diagonal shoulder belt, the method comprising:
providing an accessory for the safety harness, the accessory having a first end portion and a second end portion and a belt member extending between the first and second end portions;
attaching the first end portion to the shoulder belt at or around shoulder level;
extending the belt member around the back of a user from shoulder to hip level; and
attaching the second end portion to one of the shoulder belt at or around hip level or the buckle tongue to form a loop with the shoulder belt.

The method may include providing the first end portion with a cushion portion.

The method may include removably attaching the second end portion to the buckle tongue. The method may include adapting the accessory such that insertion of the buckle tongue into the buckle attaches the second end portion. The method may include providing the second end portion with a loop member for receiving the buckle tongue.

The method may include elasticating at least a portion of the belt member.

The method may include predetermining the elasticity of the portion of the belt member to be at least greater than the elasticity of the shoulder belt.

The method may include providing adjustment means to allow adjusting of the length of the shoulder belt between the first and second end portions.

According to a fifth aspect of the present invention there is provided an accessory for a safety harness which includes a diagonal shoulder belt, the accessory comprising:
a first end portion which is attached or attachable to the shoulder belt at or around shoulder level;
a second end portion which is attached or attachable to a mounting point of the safety harness, the mounting point being substantially immovable relative to at least a part of the safety harness; and
a belt member extending between the first and second end portions such that, in use, the belt member extends around the back of a user from shoulder to hip level, thus forming at least part of a loop with the shoulder belt to assist in maintaining the position of the shoulder belt.

The first end portion may be removably attachable to the shoulder belt. The first end portion may include a cushion portion. The first end portion may include an enclosure member which wraps around or otherwise encloses a portion of the shoulder belt at shoulder level.

The second end portion may be removably attachable to the mounting point of the safety harness.

The mounting point may be connected to the buckle attachment point of the safety harness. The mounting point may be located with the buckle attachment point of the safety harness. The mounting point may be located adjacent to the buckle attachment point of the safety harness.

The mounting point may be substantially immovable with respect to the buckle attachment point of the safety harness. That is, the mounting point may be substantially immovable with respect to the portion of the safety harness that the buckle tongue engages with. The buckle attachment point may be attached to the mounting point. The safety harness may be a vehicle safety harness and the mounting point may be part of the chassis of the vehicle. The mounting point may be formed integrally with the vehicle chassis, or attached to the vehicle chassis. The mounting point is immovable relative to the vehicle chassis. The mounting point may be an Isofix attachment point (Latch attachment point, Lucas attachment point), or anchor point.

The second end portion may include a releasable connector for attaching the second end portion to the mounting point. The releasable connector may be an Isofix connector. That is, the releasable connector may be configured to operate with an Isofix attachment point, or anchor point.

At least a portion of the belt member may be resilient or elasticated. This allows relative separation of the first and second end portions under a tensile force.

The elasticity of the portion of the belt member may be predetermined to be at least greater than the elasticity of the shoulder belt.

The belt member may be resilient or elasticated. The elasticity of the belt member may be predetermined to be at least greater than the elasticity of the shoulder belt.

The length of the shoulder belt between the first and second end portions may be adjustable.

The safety harness may comprise a three point belt system.

According to a sixth aspect of the present invention there is provided a safety harness including an accessory according to the fifth aspect of the invention.

According to a seventh aspect of the present invention there is provided a booster cushion including an accessory according to the fifth aspect of the invention.

According to an eighth aspect of the present invention there is provided a method of maintaining the position of a safety harness in use, the safety harness including a diagonal shoulder belt, the method comprising:
providing an accessory for the safety harness, the accessory having a first end portion and a second end portion and a belt member extending between the first and second end portions;
attaching the first end portion to the shoulder belt at or around shoulder level;
extending the belt member around the back of a user from shoulder to hip level; and
attaching the second end portion to a mounting point of the safety harness, the mounting point being substantially immovable relative to at least a part of the safety harness.

The method may include providing the first end portion with a cushion portion.

The method may include removably attaching the second end portion to the mounting point.

The method may include elasticating at least a portion of the belt member.

The method may include predetermining the elasticity of the portion of the belt member to be at least greater than the elasticity of the shoulder belt.

The method may include providing adjustment means to allow adjusting of the length of the shoulder belt between the first and second end portions.

Embodiments of the present invention will now be described, by way of example only, with reference to the accompanying drawings in which:

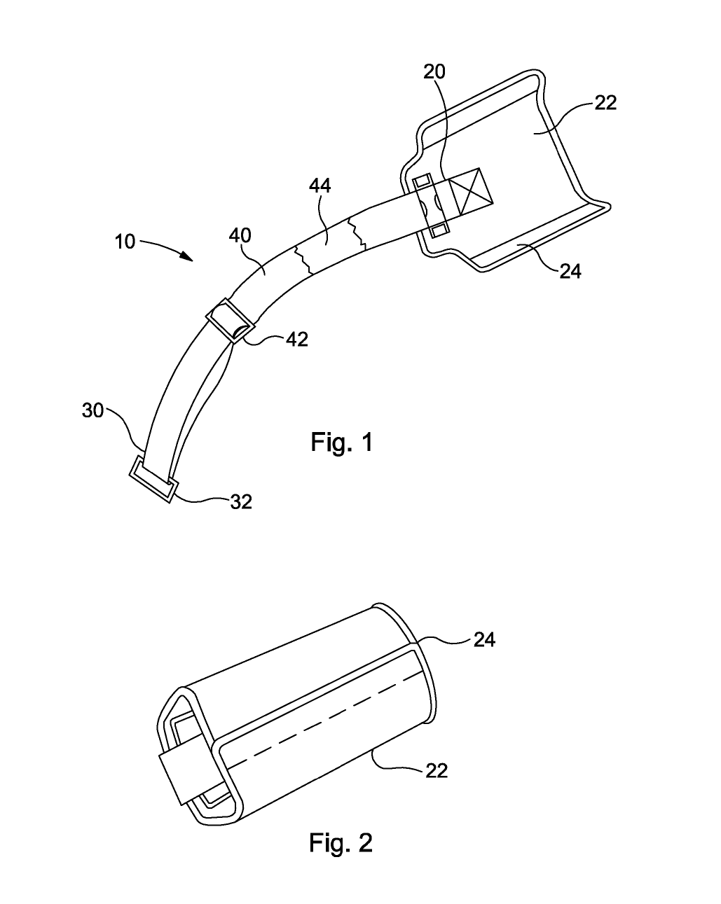

FIG. 1 is a perspective view of an accessory for a safety harness;

FIG. 2 is a perspective view of a cushion member of the accessory of FIG. 1 in a closed position;

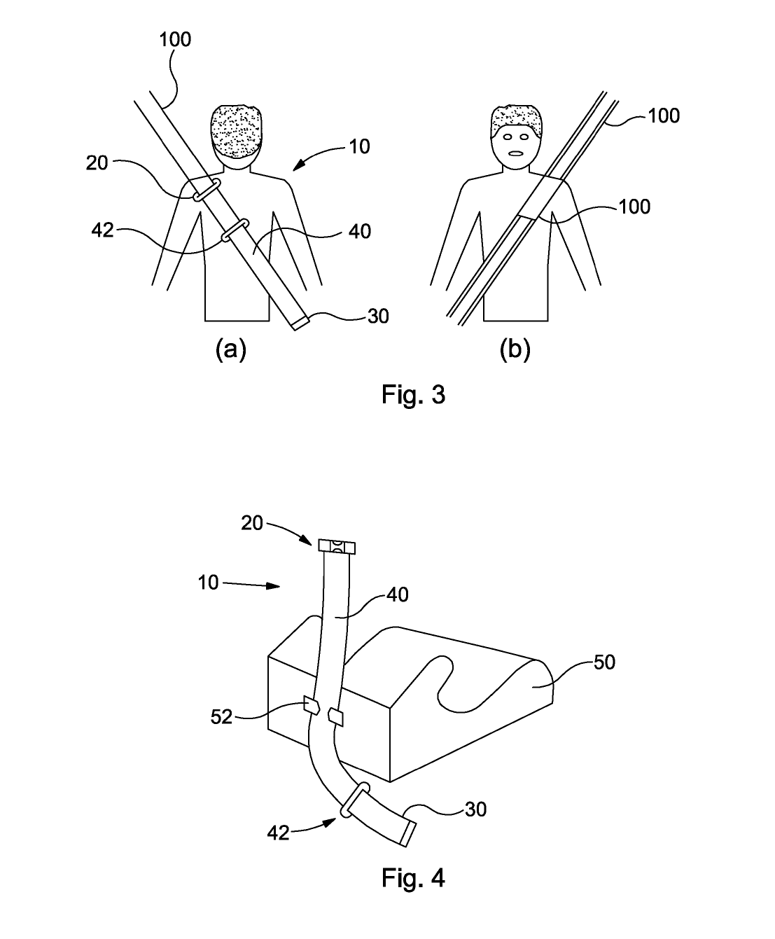

FIG. 3 is a (a) rear and (b) front view of the accessory of FIG. 1 in use and attached to a safety harness;

FIG. 4 is a perspective view of the accessory of FIG. 1 being used with a booster cushion;

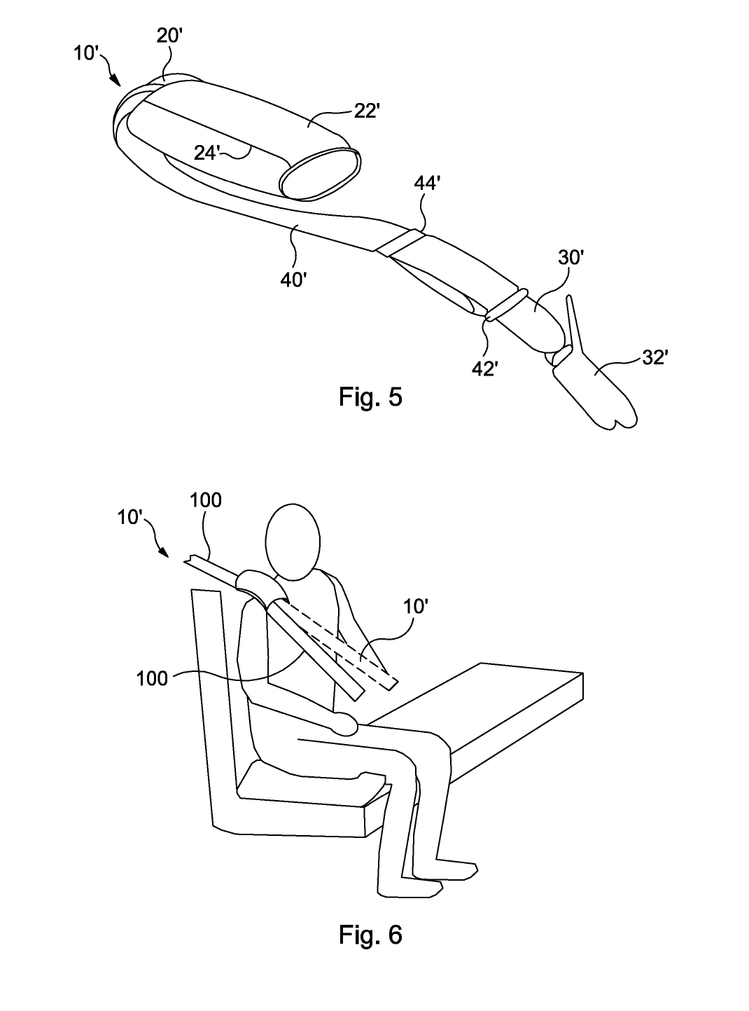

FIG. 5 is a perspective view of an alternative embodiment of the accessory of FIG. 1;

FIG. 6 is a perspective in-use view of the accessory of FIG. 5; and

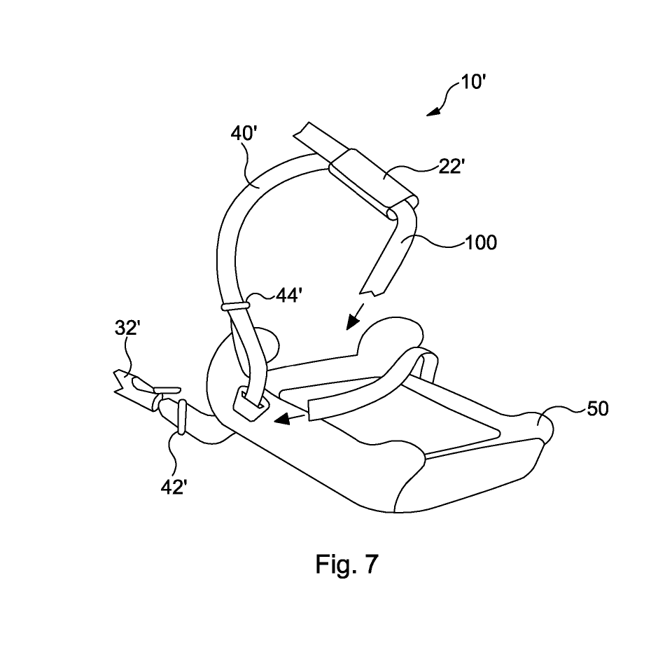

FIG. 7 is a perspective view of the accessory of FIG. 5 being used with a booster cushion.

FIG. 1 shows an accessory 10 for a vehicle seatbelt which includes a diagonal shoulder belt 100. The accessory 10 has a first end portion 20, a second end portion 30 and a belt member 40 extending between the first and second end portions.

The first end portion 20 is removably attachable to the shoulder belt 100 at shoulder level. The first end portion includes a cushion portion 22 which wraps around the width of the shoulder belt 100 at shoulder level and then fastens to itself as shown in FIG. 2. Corresponding Velcro™ strips 24 are provided for fastening. The cushion portion 22 increases comfort for the user in use, in particular by providing padding at a location which may contact the user's chin and at the sharp longitudinal edges of the shoulder belt 100.

The belt member 40 extends from the first end portion 20 to the second end portion 30 and then doubles back. The belt member 40 then feeds through a clip 42 which is slidable along the belt member 40 when the belt member 40 is loose. This provides means for adjusting the length of the belt member 40 between the first and second end portions.

A loop member 32 is provided at the second end portion 30 for receiving the buckle tongue (not shown) of the vehicle seatbelt prior to insertion into the buckle (not shown).

In use, the wearer or another (such as the carer for a child) attaches the first end portion 20 to the vehicle seatbelt 100 at shoulder level. The belt member 40 is then extended around the back of the wearer and down to hip level. The buckle tongue of the seatbelt is then inserted into the loop 32 and then the buckle. The length of the belt member 40 can then be adjusted to suit the particular wearer.

FIG. 3 shows a correctly fitted accessory 10. It can be seen that the accessory 10 forms a loop having a particular size or diameter with the vehicle seatbelt 100. This assists in maintaining a correct and comfortable position of the shoulder belt 100 and makes moving the belt from this position more difficult. In particular, it is harder for the vehicle seatbelt 100 to slip down off the wearer's shoulder, or be actively moved in this way, as the formed size of the loop is less than required for passing over the shoulder.

It is to be noted that the accessory 10, and the belt member 40 in particular, does not contribute to absorbing impact energy in a crash. Over-restraint of a user in a crash can be undesirable, such as by causing increased chest accelerations. However, particularly in an alternative embodiment of the invention, where the accessory is permanently attached to the vehicle seatbelt, the accessory 10 can be designed to contribute, with the performance of the vehicle seatbelt suitably modified.

In the illustrated embodiment, the accessory 10 simply assists to maintain the correct position of the vehicle seatbelt. To ensure that the accessory 10 does not interfere with the performance of the seatbelt, such as due to incorrect fitting, a portion 44 of the belt member is elasticated to allow relative separation of the first and second end portions. The elasticity of the portion 44 is predetermined to be greater than both the tensile and the flexural elasticity of the shoulder belt 100.

FIG. 4 shows that the accessory 10 can be used with a booster cushion 50. The booster cushion 50 can be provided with a guide 52 for receiving the belt member 40 to restrain lateral movement but allow longitudinal movement of the belt member 40.

FIG. 5 shows an alternative embodiment of an accessory 10′ for a vehicle seatbelt which includes a diagonal shoulder belt 100. The only substantial difference between the accessory 10 and accessory 10′ is that the accessory 10′ attaches to an Isofix attachment point of a vehicle (an example of a mounting point of a safety harness).

The accessory 10′ has a first end portion 20′, a second end portion 30′ and a belt member 40′ extending between the first and second end portions.

The first end portion 20′ is removably attachable to the shoulder belt 100 at shoulder level. The first end portion includes a cushion portion 22′ which wraps around the width of the shoulder belt 100 at shoulder level and then fastens to itself as shown in FIG. 5. Corresponding Velcro™ strips 24′ are provided for fastening. The cushion portion 22′ increases comfort for the user in use, in particular by providing padding at a location which may contact the user's chin and at the sharp longitudinal edges of the shoulder belt 100.

The belt member 40′ extends from the first end portion 20′ to the second end portion 30′ and then doubles back. The belt member 40′ then feeds through a clip 42′ which is slidable along the belt member 40′ when the belt member 40′ is loose. This provides means for adjusting the length of the belt member 40′ between the first and second end portions.

An Isofix attachment connector 32′ (an example of a releasable connector is provided at the second end portion 30′ for attaching to the Isofix attachment point (not shown) of the vehicle.

In use, the wearer or another (such as the carer for a child) attaches the first end portion 20′ to the vehicle seatbelt 100 at shoulder level. The belt member 40′ is then extended around the back of the wearer and down to hip level. The Isofix attachment connector 32′is connected to the Isofix attachment point of the vehicle. The seatbelt is connected in the usual manner. The length of the belt member 40′ can then be adjusted to suit the particular wearer.

FIG. 6 shows a correctly fitted accessory 10′. It can be seen that the accessory 10′ forms a substantial loop having a particular size or diameter with the vehicle seatbelt 100. As described above, this assists in maintaining a correct and comfortable position of the shoulder belt 100 and makes moving the belt from this position more difficult. In particular, it is harder for the vehicle seatbelt 100 to slip down off the wearer's shoulder, or be actively moved in this way, as the formed size of the loop is less than required for passing over the shoulder.

Again, it is to be noted that the accessory 10′, and the belt member 40′ in particular, does not contribute to absorbing impact energy in a crash. Over-restraint of a user in a crash can be undesirable, such as by causing increased chest accelerations. However, particularly in an alternative embodiment of the invention, where the accessory is permanently attached to the mounting point, the accessory 10′ can be designed to contribute, with the performance of the vehicle seatbelt suitably modified.

In the illustrated embodiment, the accessory 10′ simply assists to maintain the correct position of the vehicle seatbelt. To ensure that the accessory 10′ does not interfere with the performance of the seatbelt, such as due to incorrect fitting, a portion 44′ of the belt member is elasticated to allow relative separation of the first and second end portions. The elasticity of the portion 44′ is predetermined to be greater than both the tensile and the flexural elasticity of the shoulder belt 100.

FIG. 7 shows that the accessory 10′ can be used with a booster cushion 50. The booster cushion 50 can be provided with a guide 52 for receiving the belt member 40′ to restrain lateral movement but allow longitudinal movement of the belt member 40′.

Whilst specific embodiments of the present invention have been described above, it will be appreciated that departures from the described embodiments may still fall within the scope of the present invention. For example, although the belt member 40, 40′ has been illustrated and described above as having an elasticated portion 44, 44′, it should be appreciated that the entire belt member 40, 40′ may be elasticated. The elasticity of the belt member 40, 40′ in this arrangement is predetermined to be greater than both the tensile and the flexural elasticity of the shoulder belt 100.

1. An accessory for a safety harness which includes a diagonal shoulder belt, the accessory comprising:
a first end portion which is attached or attachable to the shoulder belt at or around shoulder level;
a second end portion which is attached or attachable to a mounting point of the safety harness, the mounting point being substantially immovable relative to at least a part of the safety harness; and
a belt member extending between the first and second end portions such that, in use, the belt member extends around the back of a user from shoulder to hip level, thus forming at least part of a loop with the shoulder belt to assist in maintaining the position of the shoulder belt.

2. An accessory as claimed in claim 1, wherein the first end portion is removably attachable to the shoulder belt.

3. An accessory as claimed in claim 1, wherein the first end portion includes a cushion portion.

4. An accessory as claimed in claim 1, wherein the first end portion includes an enclosure member which wraps around or otherwise encloses a portion of the shoulder belt at shoulder level.

5. An accessory as claimed in claim 1, wherein the second end portion is removably attachable to the mounting point of the safety harness.

6. An accessory as claimed in claim 1, wherein the mounting point is connected to the buckle attachment point of the safety harness.

7. An accessory as claimed in claim 1, wherein the mounting point of the safety harness is substantially immovable with respect to the buckle attachment point of the safety harness.

8. An accessory as claimed in claim 1, wherein the mounting point of the safety harness is connected to, or part of, the chassis of a vehicle.

9. An accessory as claimed in claim 1, wherein at least a portion of the belt member is resilient or elasticated.

10. An accessory as claimed in claim 9, wherein the elasticity of the portion of the belt member is predetermined to be at least greater than the elasticity of the shoulder belt.

11. An accessory as claimed in claim 1, wherein the length of the shoulder belt between the first and second end portions is adjustable.

12. An accessory for a safety harness which includes a diagonal shoulder belt, the accessory comprising:
a first end portion which is attached or attachable to the shoulder belt at or around shoulder level;
a second end portion which is attached or attachable to one of the shoulder belt at or around hip level or the buckle tongue; and
a belt member extending between the first and second end portions such that, in use, the belt member extends around the back of a user from shoulder to hip level, thus forming a loop with the shoulder belt to assist in maintaining the position of the shoulder belt.

13. A safety harness including an accessory according to claim 1.

14. A booster cushion including an accessory according to claim 1.

15. A car seat including an accessory according to claim 1.

16. A method of maintaining the position of a safety harness in use, the safety harness including a diagonal shoulder belt, the method comprising:
providing an accessory for the safety harness, the accessory having a first end portion and a second end portion and a belt member extending between the first and second end portions;
attaching the first end portion to the shoulder belt at or around shoulder level;
extending the belt member around the back of a user from shoulder to hip level; and
attaching the second end portion to a mounting point of the safety harness, the mounting point being substantially immovable relative to at least a part of the safety harness.

17. A method as claimed in claim 16, including providing the first end portion with a cushion portion.

18. A method as claimed in claim 16, including removably attaching the second end portion to the mounting point of the safety harness.

19. A method as claimed in claim 16, including elasticating at least a portion of the belt member.

20. A method as claimed in claim 19, including predetermining the elasticity of the portion of the belt member to be at least greater than the elasticity of the shoulder belt.

21. A method as claimed in claim 16, including providing adjustment means to allow adjusting of the length of the shoulder belt between the first and second end portions.

22. A method of maintaining the position of a safety harness in use, the safety harness including a diagonal shoulder belt, the method comprising:
providing an accessory for the safety harness, the accessory having a first end portion and a second end portion and a belt member extending between the first and second end portions;
attaching the first end portion to the shoulder belt at or around shoulder level;
extending the belt member around the back of a user from shoulder to hip level; and
attaching the second end portion to one of the shoulder belt at or around hip level or the buckle tongue to form a loop with the shoulder belt.
